(19) United States
(12) Patent Application Publication
(10) Pub. No.: US 2019/0026393 A1
(43) Pub. Date: Jan. 24, 2019

(54) Highly Custom and Scalable Design System and Method for Articles of Manufacture

(71) Applicant: SiegeTek LLC, Lenexa, KS (US)

(72) Inventors: Christopher Gregory Barnes, Stilwell, KS (US); Ryan Lynn Belcher, Overland Park, KS (US); Wayne Alexander McMann, Overland Park, KS (US)

(21) Appl. No.: 15/655,870

(22) Filed: Jul. 20, 2017

(51) Int. Cl. G06F 17/50

(52) U.S. Cl. CPC G06F 17/50; G06F 2217/12

(57) ABSTRACT

A method to shorten the time from design to manufacture, includes providing a dynamic design interface for execution on a computing device, receiving a selection of an article of manufacture, and additional design input from the user specifying color, text, and graphics and placement on the article of manufacture, and dynamically generating a production-ready design file reflecting the selected article of manufacture and each of the additional design input from the user. The production-ready design file is dynamically converted to a 2-dimensional image file, which is dynamically applied to the 3-dimensional model representation for display via the dynamic design interface. The user may easily rotate the 3-dimensional model to see all sides of the design. The production-ready design file can be used as instructions to directly print the design on the article of manufacture.

### FIELD

The present disclosure relates to computer-aided design systems and methods, and particularly to a highly custom and scalable design system and method for articles of manufacture.

### BACKGROUND

Computer-aided design (CAD) tools and other graphical applications programs have been in use for decades to facilitate design of a variety of items, from designing graphics for printing on a variety of surfaces, to designing semiconductor devices, to designing architectural plans, to designing machinery and automobiles, and even 3-dimensional or 3-D printing. However, these conventional tools and programs do not easily enable designs to be scalable to large productions and yet allow individual customization without human intervention.

### BRIEF DESCRIPTION OF THE DRAWINGS

FIG. 1 is a simplified block diagram of an exemplary embodiment of a highly custom and scalable design system and method for articles of manufacture according to the teachings of the present disclosure;

FIGS. 2-7 are representative screen shots of an exemplary embodiment of a highly custom and scalable design system and method for articles of manufacture according to the teachings of the present disclosure;

FIG. 8 is a simplified illustration of a graphical representation of a 2-dimensional image file of an article of manufacture according to the teachings of the present disclosure;

FIG. 9 is a simplified illustration of a tabular representation of a variable data input file used in the highly custom and scalable design system and method for articles of manufacture according to the teachings of the present disclosure;

FIG. 10 is a simplified block diagram of a design process in the highly custom and scalable design system and method for articles of manufacture according to the teachings of the present disclosure; and

FIG. 11 is a simplified block diagram of a manufacture process in the highly custom and scalable design system and method for articles of manufacture according to the teachings of the present disclosure.

### DETAILED DESCRIPTION

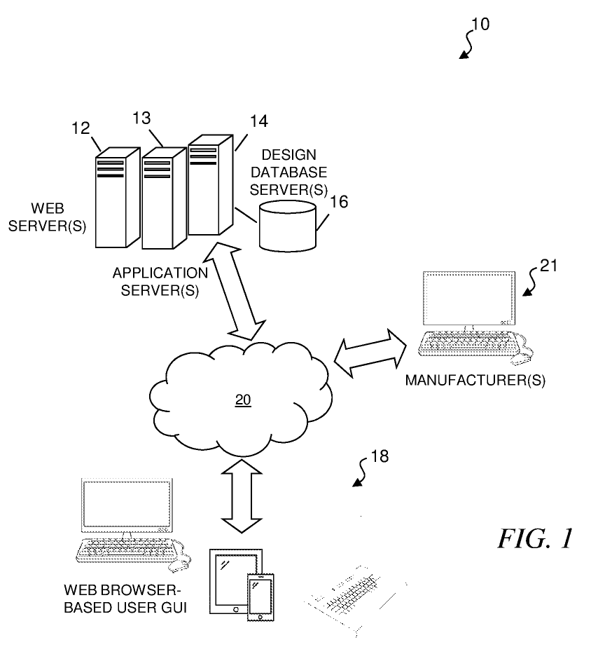

FIG. 1 is a simplified block diagram of an exemplary embodiment of a highly custom and scalable design system and method 10 for articles of manufacture according to the teachings of the present disclosure. The system 10 includes one or more servers functioning as web server(s) 12, application server(s) 13, and database server(s) 14. The web server 12 is a computer system that receives and responds to incoming requests pursuant to HTTP (Hypertext Transfer Protocol) over the Internet or World Wide Web. The application server 13 is a hardware/software framework that provides both facilities to create application programs and a server environment to run them. The database server 14 is a computer program that provides database services to store and access data in a design database 16. It should be noted that these functionalities may be handled by one server or multiple servers. The servers 12-14 and design database 16 are accessible and can communicate with a plurality of users using computing devices 18 (e.g., mobile phone, tablet computer, laptop computer, and desktop computer) via the Internet or a global computer network 20 represented by a cloud in FIG. 1. The computing devices 18 may request for a design interface web page from the web server 12 by executing a web browser application program and inputting a URL (Uniform Resource Locator) of a design website. Once the design is completed by the user, production-ready design files are stored in the design database 16, and one or more manufacturers 21 may access the database to download the production-ready design files which can be used to apply or print the designs directly onto articles of manufacture by production devices, such as printers, engravers, laser cutters, flow jets, etc.

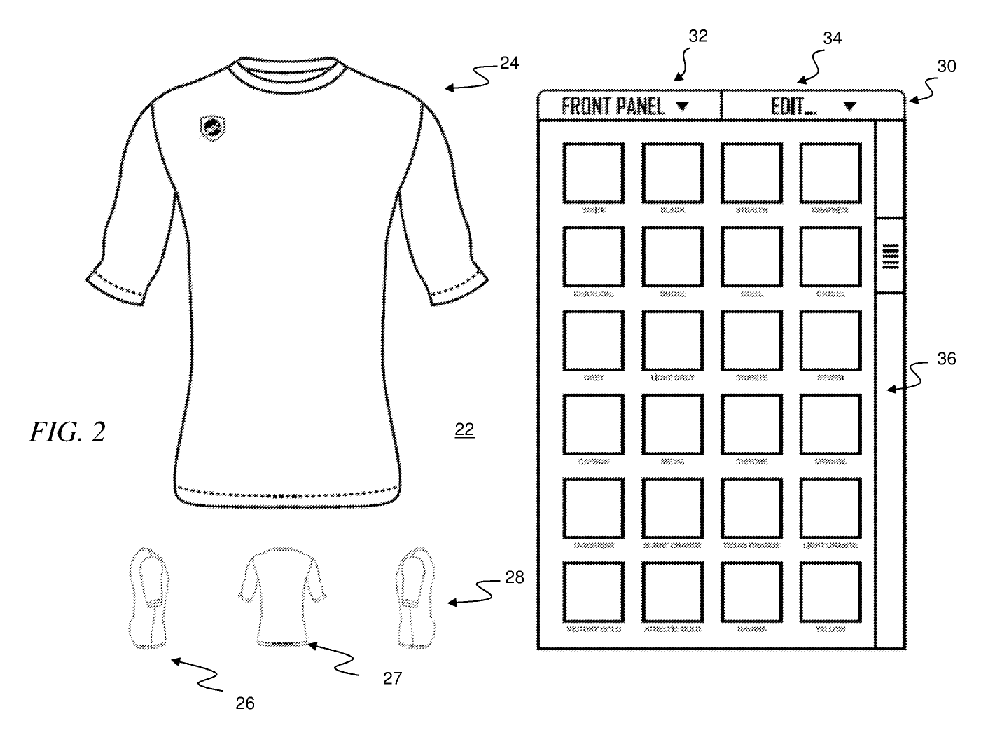

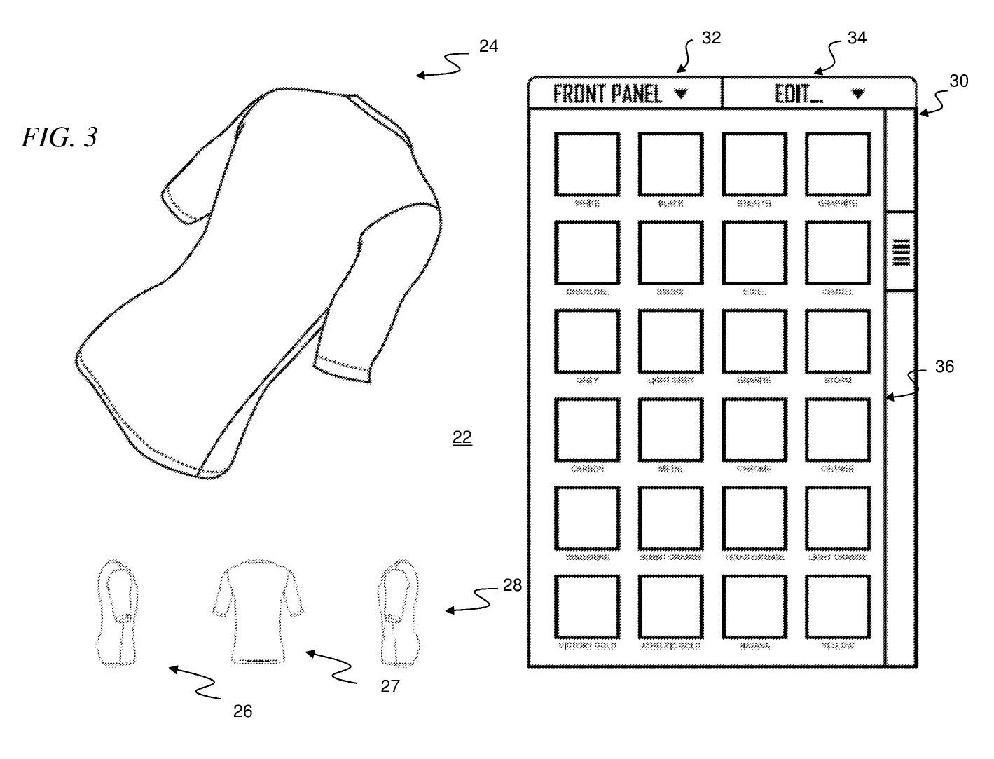

FIGS. 2-7 are representative screen shots of an exemplary embodiment of a design interface 22 of a highly custom and scalable design system and method 10 for articles of manufacture according to the teachings of the present disclosure. The design interface 22 includes a 3-dimensional primary view 24 of an article of manufacture, such as a short-sleeved sport jersey shown in FIGS. 2-7. The user may choose a particular type of article of manufacture for design input, such as sports uniforms (e.g., for football, soccer, basketball, baseball, volleyball, track, etc.), coffee cups, pens, pencils, and even automobile exteriors, etc. A production-ready design file representing a template of the selected article of manufacture is generated in response to the user's selection. The production-ready design file may be, for example, a vector-based file format, such as EPS (Encapsulated PostScript), SVG (Scalable Vector Graphics), PDF (Portable Document Format), AI (Adobe Illustrator Artwork), and DXF (Drawing eXchange Format), CAD (Computer-Aided Design), CAM (Computer-Aided Manufacturing), and CAE (Abaqus /CAE CAE Model). As shown in FIG. 3, the user may manipulate the 3-dimensional model in the primary view 24 to rotate and orient the model to see different sides of the article. Also displayed by the design interface 22 are selected secondary views of the article, such as views of the right side 26, back side 27, and left side 28 of the article.

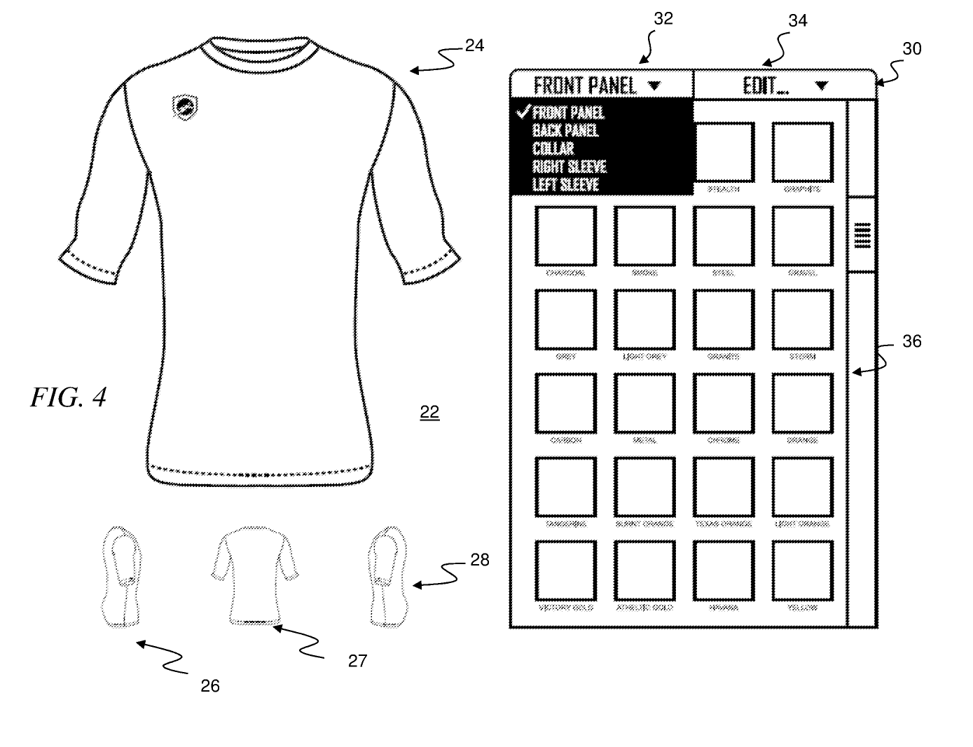

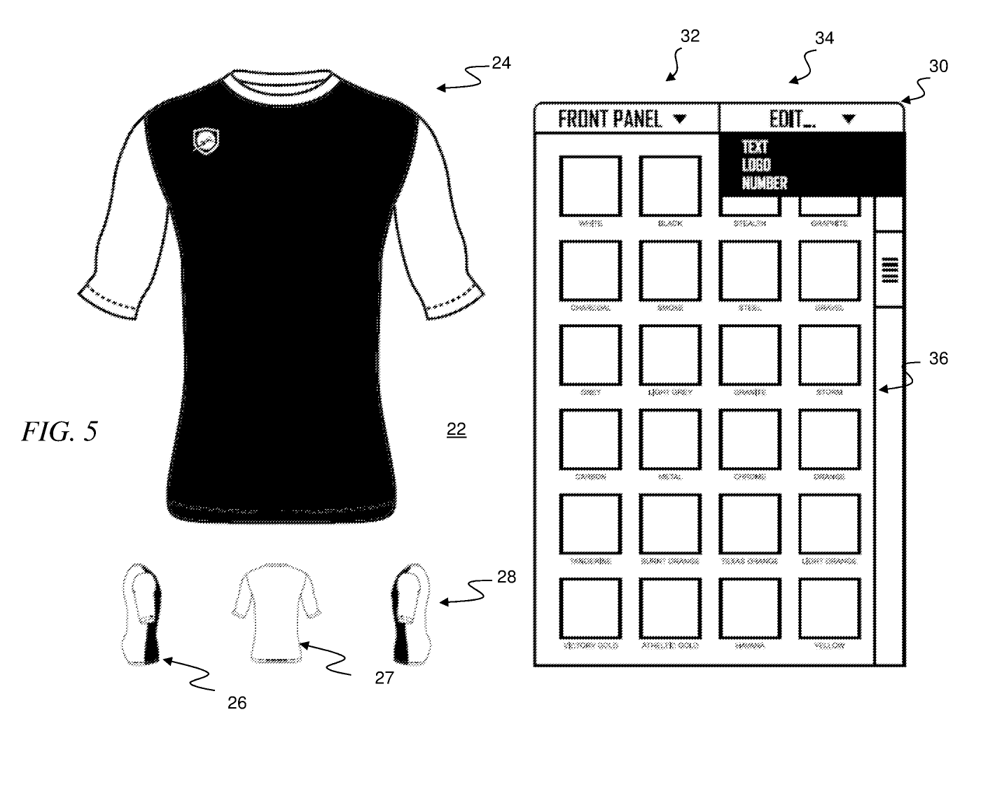

The design interface 22 also includes a design input panel 30 that enables the user to specify colors and other design elements such as text, numbers, and graphics to be added to the design. For example, an input menu 32 enables the user to select a specific portion of the article, e.g., front panel, back panel, collar, right sleeve, and left sleeve, as shown in FIG. 4. An input menu 34 enables the user to select design elements TEXT, LOGO, or NUMBER for input, as shown in FIG. 5. Alternatively, the user may specify placement of the design element by providing a coordinate measured from a predetermined point on the article. Further, a color palette 36 is provided to enable the user to specify a color to be applied to a selected portion of the article. In the example shown in FIG. 5, the user has selected a color to be added to the front panel of the jersey. As soon as the user provides a design input, the production-ready design file is dynamically updated to reflect the user's design input. The production-ready design file is then converted to a two-dimensional image file in a format such as bitmap or another image format, and applied to the 3-dimensional model shown on the screen in real-time. The image file format may include, for example, 3D Studio Max (.max, .3ds), AC3D (.AC), Apple 3DMF (.3dm/.3dmf), Autocad (.dwg), Blender (.blend), Caligari Object (.cob), Collada (.dae), Dassault (.3dxm1), DEC Object File Format (.off), DirectX 3D Model (.x), Drawing Interchange Format (.dxf), DXF Extensible 3D (.x3d), Form-Z (.fmz), GameExchange2-Mirai (.gof), Google Earth (.kml/.kmz), HOOPS HSF (.hsf), LightWave (.lwo/.lws), Lightwave Motion (.mot), MicroStation (.dgn), Nendo (.ndo), OBJ (.obj), Okino Transfer File Format (.bdf), OpenFlight (.flt), Openinventor (.iv), Pro Engineer (.slp), Radiosity (.radio), Raw Faces (.raw), RenderWare Object (.rwx), Revit (.rvt), Sketchup (.skp), Softimage XSI (.xsi), Stanford PLY (.ply), STEP (.stp), Stereo Litography (.st1), Strata StudioPro (.vis), TrueSpace (.cob), trueSpace (.cob, .scn), Universal (.u3d), VectorWorks (.mcd), VideoScape (.obj), Viewpoint (.vet), VRML (.wr1), Wavefront (.obj), Wings 3D (.wings), X3D Extensible 3D (.x3d), Xfig Export (.fig). Each design change made by the user results in a change to the production-ready design file and change to the two-dimensional image file, which leads to a real-time update of the 3-dimensional model displayed by the design interface web page. The production-ready design file produced in this manner contains instructions that can be provided as input directly to a production device for printing or applying the user's design input onto the selected article of manufacture. A production device may include, for example, printers, engravers, laser cutters, flow jets, etc.

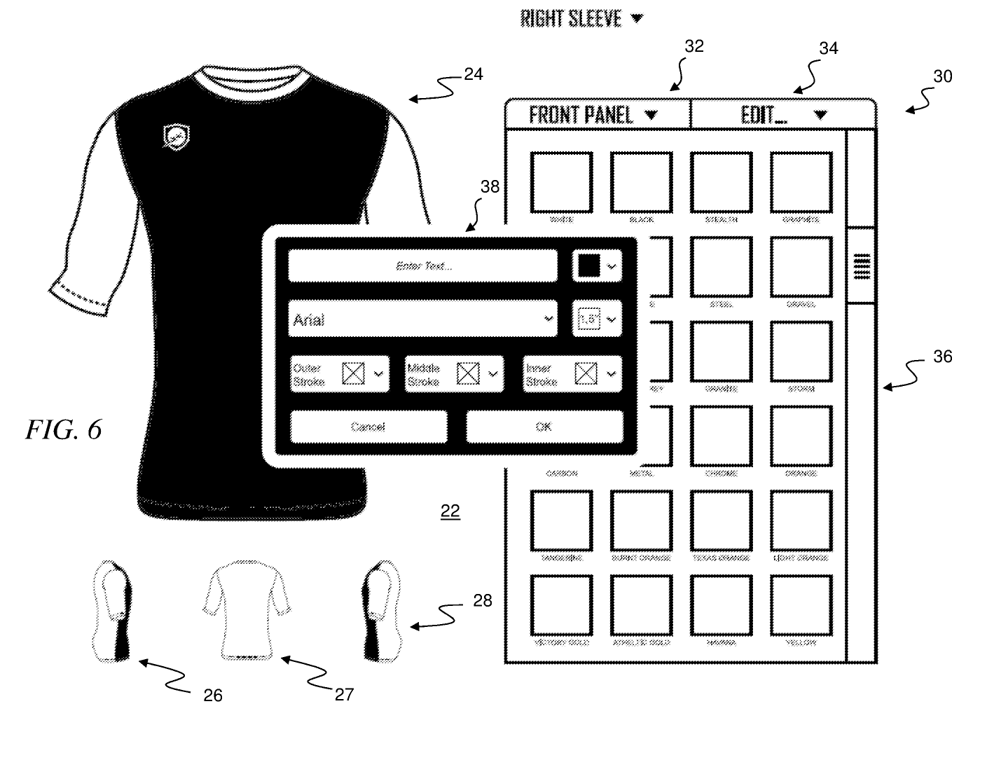

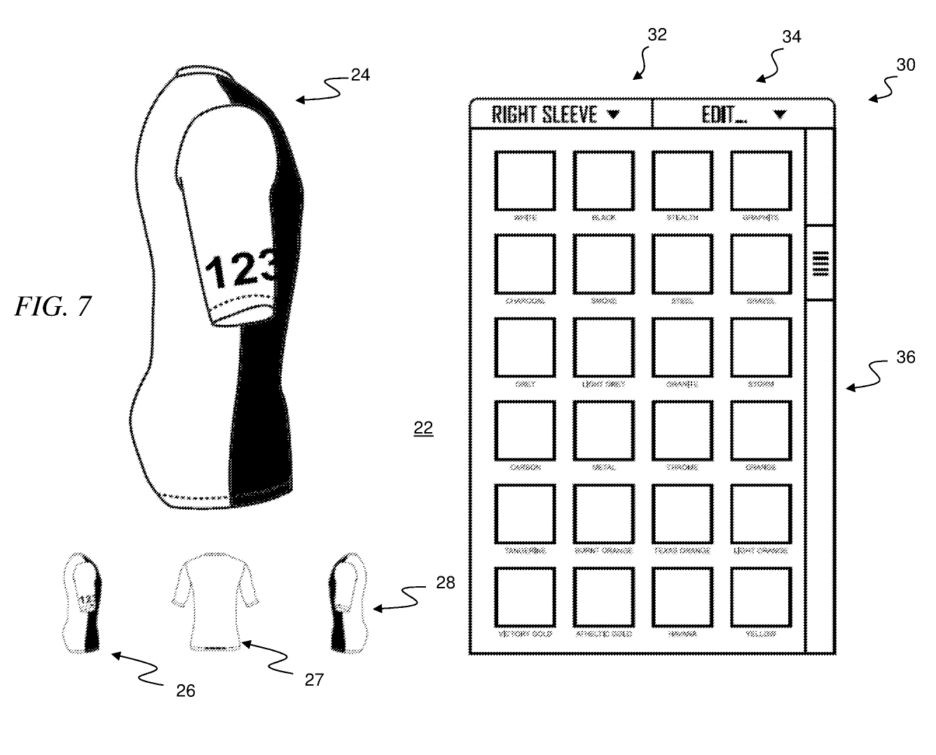

By selecting a specific portion of the article, the user may specify and choose additional design elements to be applied to the selected portion. For example, the user may select a color from the color palette 36 for the front panel of the sports jersey, as shown in FIGS. 4 and 5. As soon as the user inputs the design element, the primary and secondary views of the article of manufacture are immediately updated to reflect the addition of the new design element. As shown in FIG. 6, a text entry box 38 is displayed in response to the user's selection of “TEXT” in the input menu 34. The user may specify the text, font, size, and color(s) for the inside, middle, and outside strokes of the text. FIG. 7 shows the 3-dimensional model dynamically reflecting the user's design input of the numbers “123” applied to the right sleeve.

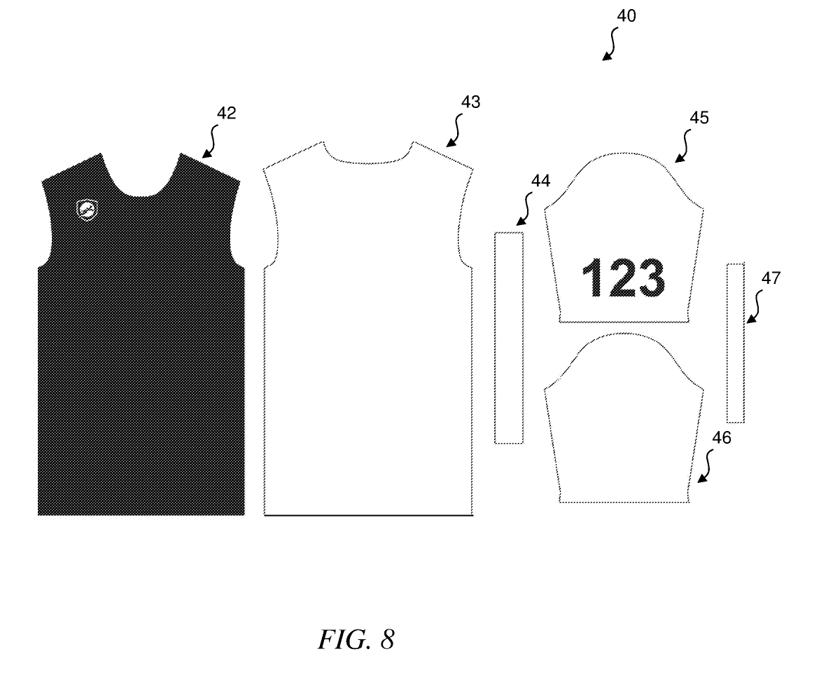

FIG. 8 is a simplified illustration of a graphical representation of a 2-dimensional image file 40 of an article of manufacture according to the teachings of the present disclosure. This 2-dimensional image file 40 is generated from the production-ready design file that contains all of the user's design inputs. The two-dimensional image file 40 includes all of the design input for all of the portions 42-47 of the article of manufacture. This 2-dimensional image file is then applied to the 3-dimensional model displayed by the dynamic design interface for viewing by the user. Each design input received from the user is reflected in the production-ready design file and in turn the 2-dimensional image file that is displayed by the dynamic design interface on the 3-dimensional model.

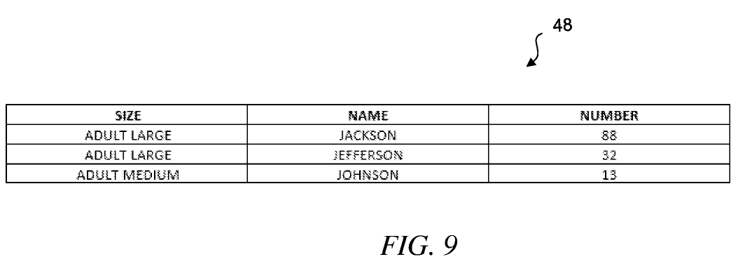

FIG. 9 is a simplified illustration of a tabular representation of a variable data input file 48 used in the highly custom and scalable design system and method 10 for articles of manufacture according to the teachings of the present disclosure. The variable data input file 48 includes data used to further customize each individual piece of article of manufacture. For example, if forty sports jerseys will be fabricated for a sports team, the name, the size, and jersey number of each player are specified in this file 48. The data from the variable data input file 48 are incorporated with the production-ready design file to generate forty individual production-ready design files, one for each player's jersey. The resultant forty production-ready files are then sent directly to the production devices/machines to apply the designs (names and numbers) onto the proper size blank jerseys to produce forty sports jerseys.

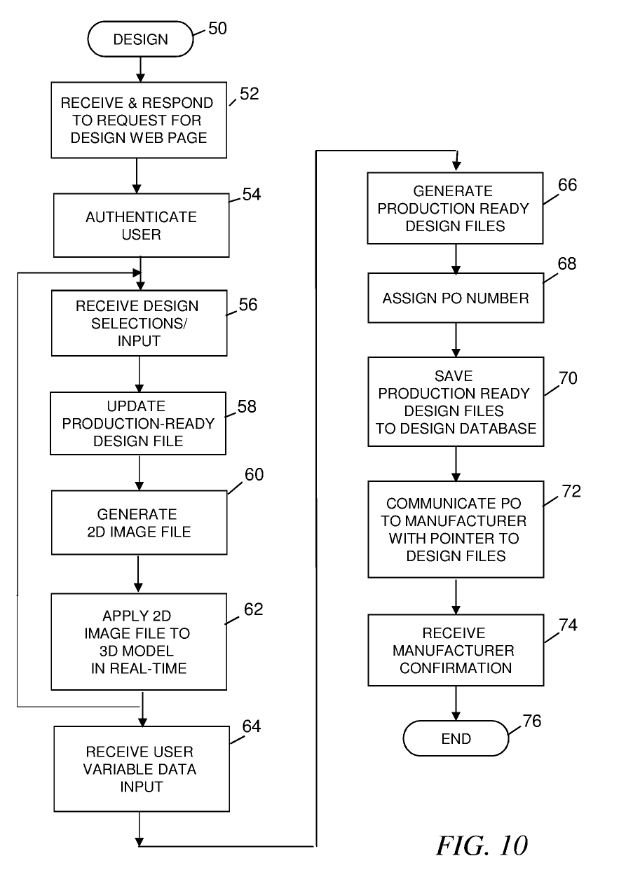

FIG. 10 is a simplified block diagram of a design process 50 in the highly custom and scalable design system and method 10 for articles of manufacture according to the teachings of the present disclosure. As shown in bocks 52 and 54, a user may create an account and login information so that the user can be authenticated prior to accessing the design interface website. The web server receives and responds to the user's request for the design interface web page in order for the user to select an article of manufacture and provide design input. A production-ready design file is created for the template of the article of manufacture selected by the user. The design interface web page displays a 3-dimensional model of the selected article of manufacture that can be manipulated and oriented by the user. In blocks 56 and 58, user design inputs and selections for color, text, number, and graphics are received, and these design inputs are reflected in the production-ready design file. The changes in the production-ready design file is also reflected in a 2-dimensional image file, which is applied to the 3-dimensional model displayed by the design interface web page in real-time, as shown in blocks 60 and 62. As these design inputs are received, the production-ready design file is updated with the additional design inputs, and the 2-dimensional image file is also updated to reflect the design inputs in real-time. The 3-dimensionl model displayed on the screen of the computing device is also dynamically updated to reflect the changes. In block 64, the user may optionally upload a variable data input file that contains data to custom tailor each article to be manufactured or fabricated. A set of production-ready design files that incorporates data from the variable data input file is then generated, as shown in block 66. A unique identifier is then assigned to the job, such as a purchase order (PO) number, as shown in block 68. The files are then stored in the design database, as shown in block 70. The user may also choose to save a template file that contain at least some of the design elements so that later projects can start from the stored template instead from a blank template. In block 72, the unique identifier and a pointer to the design files in the database are communicated electronically to one or more manufacturer tasked with fabricating the articles of manufacture. The pointer may be a URL to the location of the design files. In block 74, a confirmation is received from the manufacture to acknowledge the receipt of the information for the job. The manufacturer may then download the set of production-ready design files and send them directly to the production machine. The process ends in block 76.

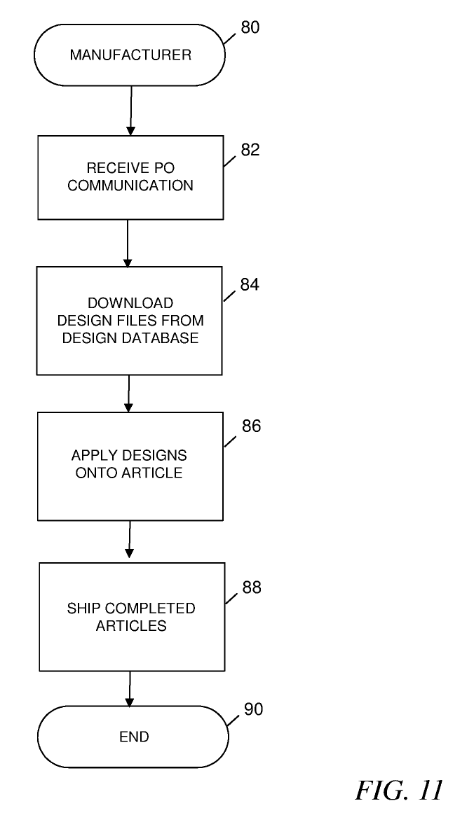

FIG. 11 is a simplified block diagram of a manufacture process 80 in the highly custom and scalable design system and method for articles of manufacture according to the teachings of the present disclosure. A manufacturer receives the electronic communication containing the unique identifier and pointer reference to the set of production-ready design files, as shown in block 82. The manufacturer downloads the design files from the design database, as shown in block 84. Access to the database by the manufacturer may require authentication before file download is granted. The manufacturer may then send the set of production-ready design files directly to the production device to print the designs onto the articles of manufacture, as shown in block 86. Thereafter in block 88 the finished articles are then shipped to a predetermined agreed-upon destination. The process ends in block 90.

The custom design system and method described herein are able to highly automate the time from design to manufacture giving the user the ability to specify custom design elements for the articles of manufacture down to the individual items. The entire design process to manufacture is highly automated and easily scalable to different types of articles sharing the same design elements and high production volumes as well as single item productions.

It should be noted that the word “printing” used herein loosely means to apply some form of design to a surface in the form of, but not limited to, inks, cutting, engraving, embossing, molding, and/or 3D printing.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. A method, comprising:
receiving a request for a dynamic design interface web page from a computing device;
transmitting the dynamic design interface web page to the computing device, the dynamic design interface web page being configured to receive user design input and dynamically render and display the design input on a 3-dimensional model representation;
receiving a selection from the user selecting a template representing an article of manufacture;
transmitting the 3-dimensional model representation to the computing device for display via the dynamic design interface web page;
receiving design inputs from the user specifying at least one of color and its placement on the article of manufacture, text and its placement on the article of manufacture, and a graphics file containing a graphics design and its placement on the article of manufacture;
dynamically generating and updating a production-ready design file reflecting each of the design input from the user;
dynamically converting the production-ready design file to a 2-dimensional image file and updating the 2-dimensional image file to reflect each of the design input from the user;
dynamically applying the 2-dimensional image file to the 3-dimensional model representation of the selected template representing the article of manufacture reflecting each of the design input from the user being displayed by the computing device via the dynamic design interface web page;
receiving a variable data input file specifying a set of customization input from the user;
generating a final set of production-ready design files including data from the variable data input file, each production-ready design file containing design printing instructions for each of a plurality of articles of manufacture; and
storing the final set of production-ready design files in a database accessible via a global computer network.

2. The method of claim 1, further comprising:
generating a hypertext link to a location of the final set of production-ready design files in the database; and
transmitting the hypertext link to a manufacture.

3. The method of claim 1, wherein storing the final set of production-ready design files comprises associating the final set of production-ready design files with a unique identifier.

4. The method of claim 1, wherein receiving the variable data input file comprises receiving custom design input for each of a plurality of articles of manufacture.

5. The method of claim 1, wherein receiving the variable data input file comprises receiving an athlete name and a jersey number for each of a plurality of sport jerseys.

6. The method of claim 1, wherein receiving a graphics file comprises receiving an image file representation of a team logo.

7. The method of claim 1, wherein dynamically generating a production-ready design file comprises dynamically generating a file with a format selected from the group consisting of EPS (Encapsulated PostScript), SVG (Scalable Vector Graphics), PDF (Portable Document Format), AI (Adobe Illustrator Artwork), DXF (Drawing eXchange Format), CAD (Computer-Aided Design), CAM (Computer-Aided Manufacturing), and CAE (Abaqus /CAE CAE Model).

8. The method of claim 1, wherein receiving additional design input from the user comprises:
providing a menu listing a plurality of defined parts of the selected template representing the article of manufacture;
receiving a user input selecting one of the plurality of defined parts; and
receiving a user input selecting a color to be applied to the selected one of the plurality of defined parts.

9. The method of claim 1, wherein receiving additional design input from the user comprises:
providing a menu listing a plurality of defined parts of the selected template representing the article of manufacture;
receiving a user input selecting one of the plurality of defined parts; and
receiving a user input specifying text to be applied to the selected one of the plurality of defined parts.

10. The method of claim 1, wherein receiving additional design input from the user comprises:
providing a menu listing a plurality of defined parts of the selected template representing the article of manufacture;
receiving a user input selecting one of the plurality of defined parts; and
receiving a user input specifying a graphics design to be applied to the selected one of the plurality of defined parts.

11. The method of claim 1, further comprising user input to rotate the 3-dimensional model representation of the article of manufacture.

12. A method, comprising:
providing a dynamic design interface for execution on a computing device;
receiving a request from the dynamic design interface executing on the computing device;
receiving a design input from the user selecting an article of manufacture;
transmitting a 3-dimensional model representation of the selected article of manufacture to the computing device for display via the dynamic design interface, the 3-dimensional model being rotatable by user manipulation;
receiving additional design input from the user specifying at least one of color and its placement on the article of manufacture, text and its placement on the article of manufacture, and a graphics file containing a graphics design and its placement on the article of manufacture;
dynamically generating a production-ready design file reflecting the selected article of manufacture and each of the additional design input from the user;
dynamically converting the production-ready design file to a 2-dimensional image file;
dynamically updating the 2-dimenstional image file to reflect each additional design input from the user;
dynamically applying an updated 2-dimensional image file to the 3-dimensional model representation and transmitting the 3-dimensional model representation reflecting each of the additional design input from the user to the computing device for display via the dynamic design interface;
generating a final set of production-ready design files, each production-ready design file containing design printing instructions for each of a plurality of articles of manufacture; and
associating the final set of production-ready design files with a unique identifier and storing the final set of production-ready design files in a database accessible via a global computer network.

13. The method of claim 12, further comprising:
generating a pointer to a location of the final set of production-ready design files in the database; and
transmitting the pointer to a manufacture for downloading the final set of production-ready design files.

14. The method of claim 12, further comprising receiving a variable data input file containing custom design input for each of a plurality of articles of manufacture.

15. The method of claim 12, further comprising receiving a variable data input file containing an athlete name and a jersey number for each of a plurality of sport jerseys.

16. The method of claim 12, further comprising receiving a variable data input file containing an athlete name and a player number for each of a plurality of articles of clothing for a sports team.

17. The method of claim 12, wherein receiving a graphics file comprises receiving an image file representation of a team logo.

18. The method of claim 12, wherein dynamically generating a production-ready design file comprises dynamically generating a file with a format selected from the group consisting of EPS (Encapsulated PostScript), SVG (Scalable Vector Graphics), PDF (Portable Document Format), AI (Adobe Illustrator Artwork), DXF (Drawing eXchange Format), CAD (Computer-Aided Design), CAM (Computer-Aided Manufacturing), and CAE (Abaqus/CAE CAE Model).

19. The method of claim 12, wherein receiving additional design input from the user comprises:
providing a menu listing a plurality of defined parts of the selected article of manufacture;
receiving a user input selecting one of the plurality of defined parts; and
receiving a user input selecting a color to be applied to the selected one of the plurality of defined parts.

20. The method of claim 12, wherein receiving additional design input from the user comprises:
providing a menu listing a plurality of defined parts of the selected article of manufacture;
receiving a user input selecting one of the plurality of defined parts; and
receiving a user input specifying text to be applied to the selected one of the plurality of defined parts.

21. The method of claim 12, wherein receiving additional design input from the user comprises:
providing a menu listing a plurality of defined parts of the selected article of manufacture;
receiving a user input selecting one of the plurality of defined parts; and
receiving a user input specifying a graphics design to be applied to the selected one of the plurality of defined parts.

22. A system, comprising:
a database accessible by a global computer network;
a web server configured to:
receive a request for a dynamic design interface web page from a computing device;
transmit the dynamic design interface web page to the computing device;
receive a design input from the user selecting a template representing an article of manufacture;
transmit a 3-dimensional model representation of the selected template to the computing device for display via the dynamic design interface web page, the 3-dimensional model being rotatable by user manipulation;
receive additional design input from the user specifying at least one of color and its placement on the article of manufacture, text and its placement on the article of manufacture, and a graphics file containing a graphics design and its placement on the article of manufacture;
dynamically generate a production-ready design file reflecting the selected template and each of the additional design input from the user;
dynamically convert the production-ready design file to a 2-dimensional image file;
dynamically update the 2-dimenstional image file to reflect each additional design input from the user;
dynamically apply an updated 2-dimensional image file to the 3-dimensional model representation and transmit the 3-dimensional model representation reflecting each of the additional design input from the user to the computing device for display via the dynamic design interface web page;
generate a final set of production-ready design files, each production-ready design file containing design printing instructions for each of a plurality of articles of manufacture; and
associate the final set of production-ready design files with a unique identifier and storing the final set of production-ready design files in a database accessible via a global computer network.

23. The system of claim 22, wherein the web server is further configured to:
generate a pointer to a location of the final set of production-ready design files in the database; and
transmit the pointer to a manufacture for downloading the final set of production-ready design files.

24. The system of claim 22, wherein the web server is further configured to receive a variable data input file containing custom design input for each of a plurality of articles of manufacture.

25. The system of claim 22, wherein the web server is further configured to receive a variable data input file containing an athlete name and a jersey number for each of a plurality of sport jerseys.

26. The system of claim 22, wherein the web server is further configured to receive a variable data input file containing an athlete name and a payer number for each of a plurality of articles of clothing for a sports team.

27. The system of claim 22, wherein the web server is further configured to receive a graphics file comprises receiving an image file representation of a team logo.

28. The system of claim 22, wherein the web server is further configured to:
provide a menu listing a plurality of defined parts of the selected template representing the article of manufacture;
receive a user input selecting one of the plurality of defined parts; and
receive a user input selecting a color to be applied to the selected one of the plurality of defined parts.

29. The system of claim 22, wherein the web server is further configured to:
provide a menu listing a plurality of defined parts of the selected template representing the article of manufacture;
receive a user input selecting one of the plurality of defined parts; and
receive a user input specifying text to be applied to the selected one of the plurality of defined parts.

30. The system of claim 22, wherein the web server is further configured to:
provide a menu listing a plurality of defined parts of the selected template representing the article of manufacture;
receive a user input selecting one of the plurality of defined parts; and
receive a user input specifying a graphics design to be applied to the selected one of the plurality of defined parts.
